(19) United States
(12) Patent Application Publication
(10) Pub. No.: US 2017/0205825 A1
(43) Pub. Date: Jul. 20, 2017

(54) SYSTEM AND METHOD FOR NEGOTIATING AN INTERSECTION TRAVERSAL BY AN AUTOMATED VEHICLE

(71) Applicant: Faraday&Future Inc., Gardena, CA (US)

(72) Inventors: Chongyu WANG, Torrance, CA (US); Bibhrajit HALDER, Palo Alto, CA (US)

(21) Appl. No.: 15/410,591

(22) Filed: Jan. 19, 2017

Related U.S. Application Data
(60) Provisional application No. 62/280,534, filed on Jan. 19, 2016.

(51) Int. Cl. G05D 1/00; G08G 1/16; B60W 30/18; G08G 1/0962

(52) U.S. Cl. CPC G05D 1/0088; G08G 1/09623; G08G 1/162; B60W 30/18154; H04W 4/008

(57) ABSTRACT

The present invention relates to a system and method for negotiating priority of entry into a traffic intersection as between multiple vehicles. Specifically, examples of the disclosure are directed to a peer-to-peer negotiation system for intersections including all-way stop signs. Where multiple automated vehicles come together at an intersection, the vehicles can use an intelligent negotiation system to determine when each vehicle should enter the intersection. In this way, a safer, more orderly traversal of the intersection can be accomplished without relying on an external arbitration device for each intersection.

### CROSS REFERENCE TO RELATED APPLICATION

This application claims the benefit of U.S. Provisional Patent Application No. 62/280,534, filed on Jan. 19, 2016, the entire disclosure of which is incorporated herein by reference in its entirety for all intended purposes.

### FIELD OF THE DISCLOSURE

This relates generally to negotiation of an intersection traversal by an automated vehicle.

### BACKGROUND OF THE DISCLOSURE

Modern vehicles, especially automobiles, increasingly provide automated driving and driving assistance systems such as blind spot monitors, automatic parking, and automatic navigation. However, automated driving systems can have difficulty traversing intersections, especially when other automated vehicles are involved.

### SUMMARY OF THE DISCLOSURE

Examples of the disclosure are directed to a peer-to-peer negotiation system for intersections including all-way stop signs. Where multiple automated vehicles come together at an intersection, the vehicles can use an intelligent negotiation system to determine when each vehicle should have priority in entering the intersection. In this way, a safer, more orderly traversal of the intersection can be accomplished without relying on an external arbitration device for each intersection.

### BRIEF DESCRIPTION OF THE DRAWINGS

FIGS. 1A-1H illustrate an exemplary intersection negotiation according to examples of the disclosure.

FIG. 2 illustrates an exemplary method of intersection negotiation according to examples of the disclosure.

FIG. 3 illustrates a system block diagram according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Modern vehicles, especially automobiles, increasingly provide automated driving and driving assistance systems such as blind spot monitors, automatic parking, and automatic navigation. However, automated driving systems can have difficulty traversing intersections, especially when other automated vehicles are involved.

Examples of the disclosure are directed to a peer-to-peer negotiation system for intersections including all-way stop signs. Where multiple automated vehicles come together at an intersection, the vehicles can use an intelligent negotiation system to determine when each vehicle should enter the intersection. Each vehicle can communicate its time of arrival to the other vehicles, and the vehicle with the earliest time of arrival can be the first to enter the intersection. Further, each vehicle can communicate to the other vehicles once it has entered the intersection and once it has exited the intersection. Once the other vehicles receive a message indicating that the vehicle has exited the intersection, the negotiation process can begin again, and the remaining vehicle with the earliest time of arrival can enter the intersection. In this way, a safer, more efficient traversal of the intersection can be accomplished without relying on an external arbitration device for each intersection.

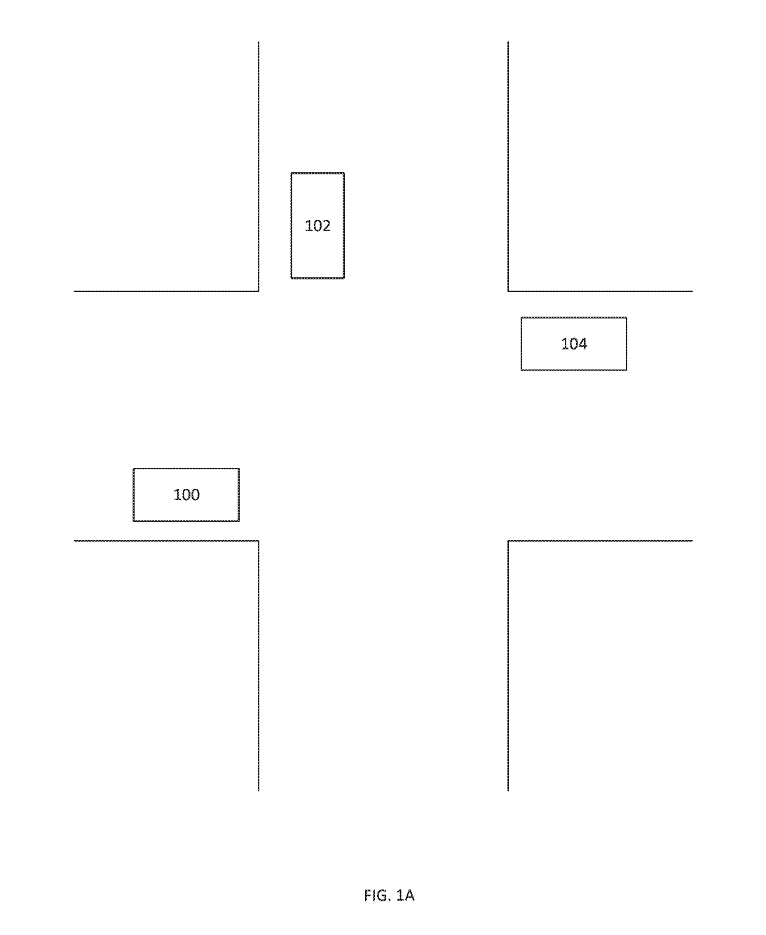

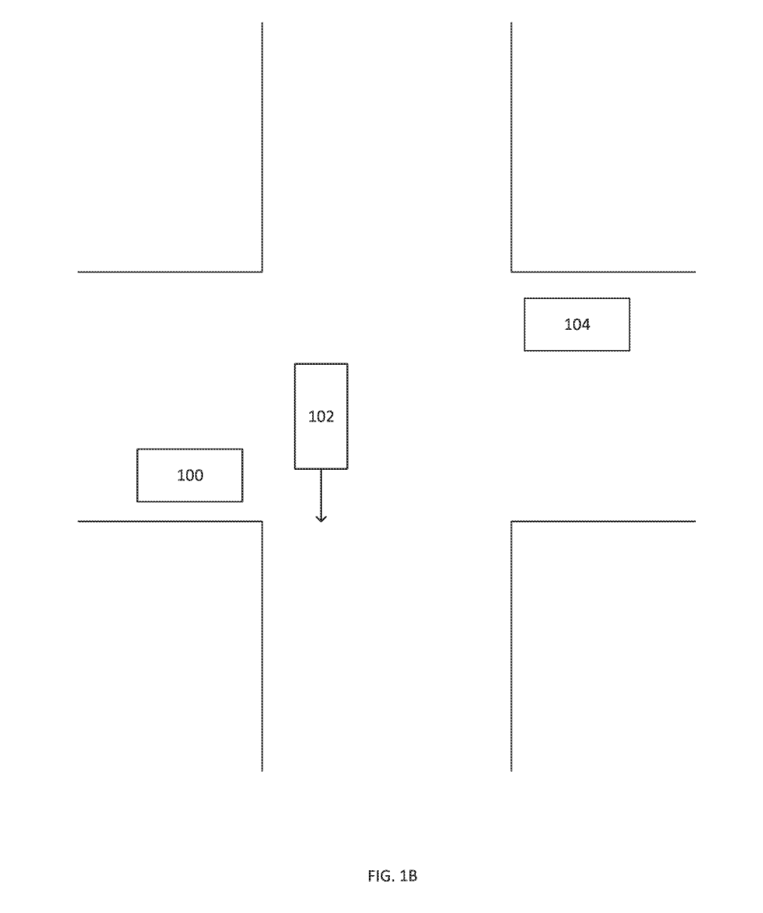

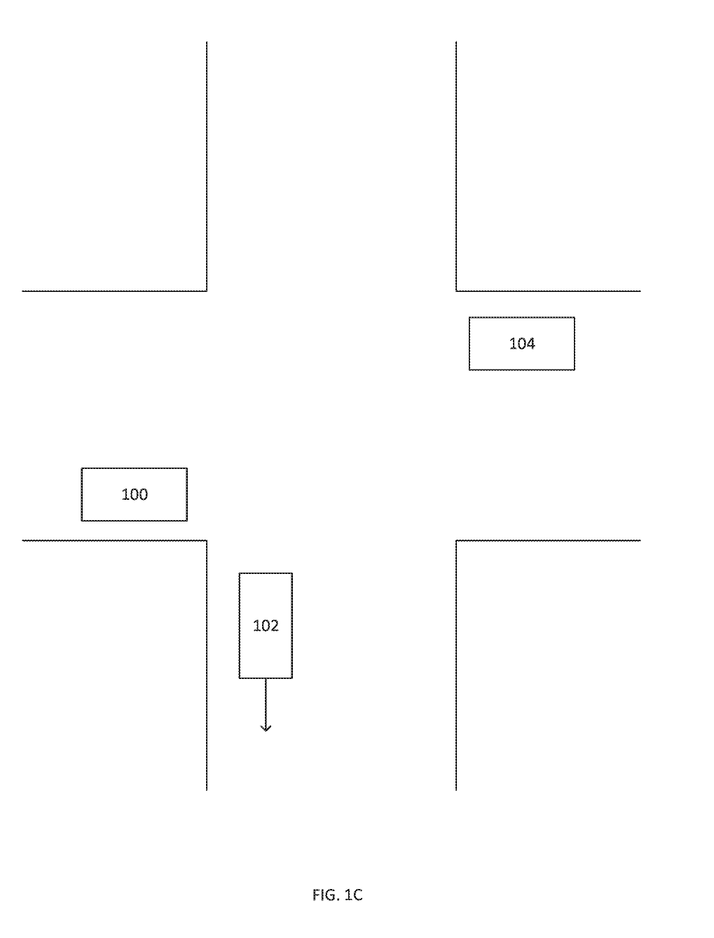

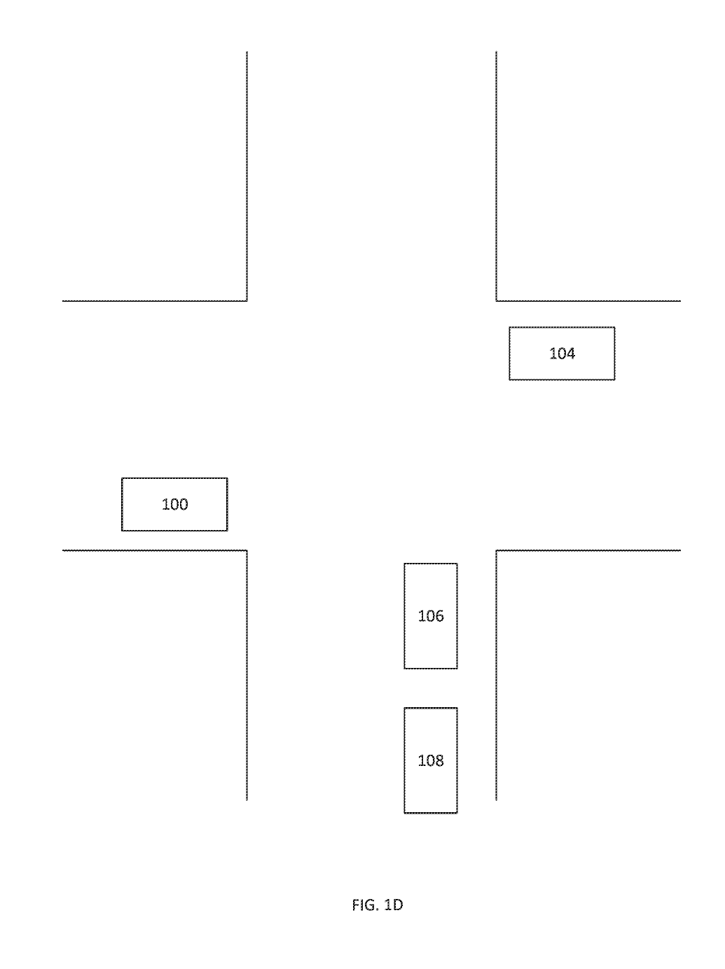

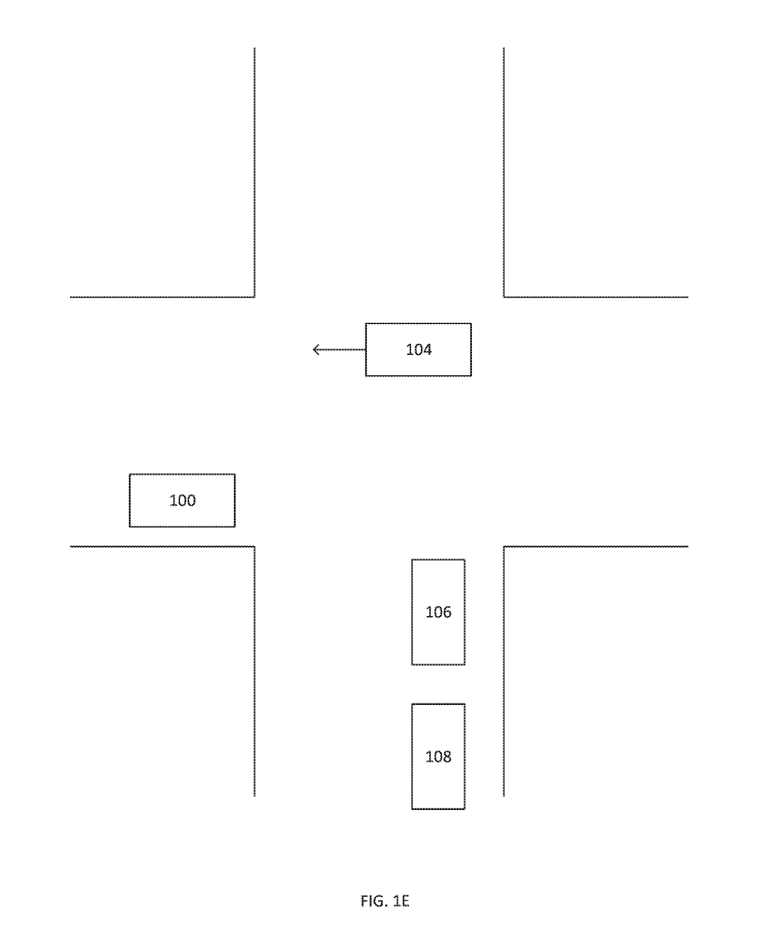

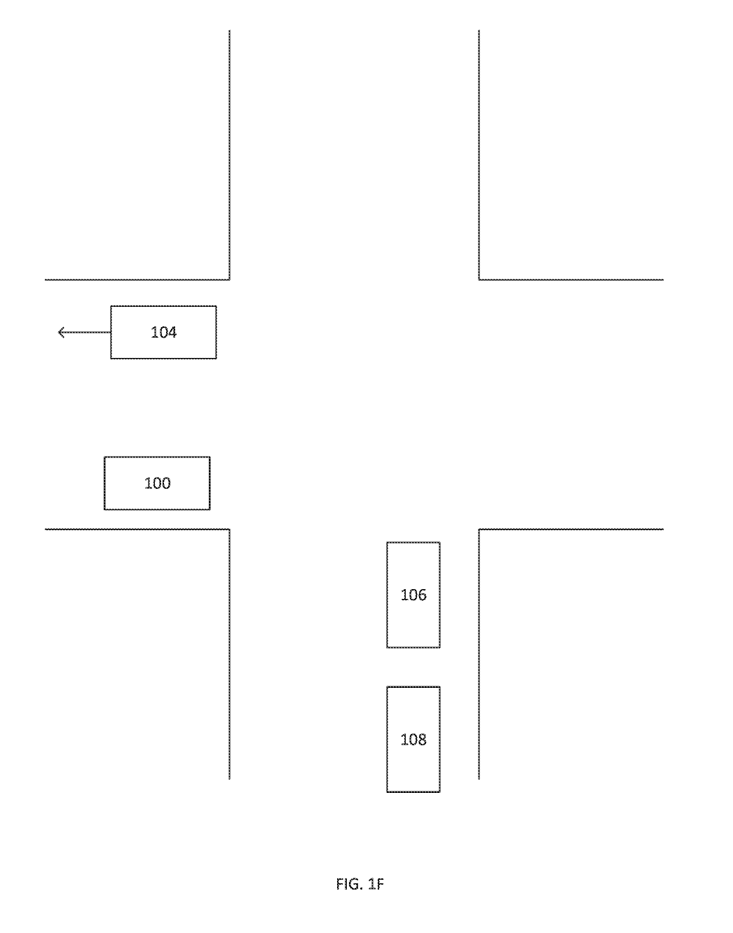

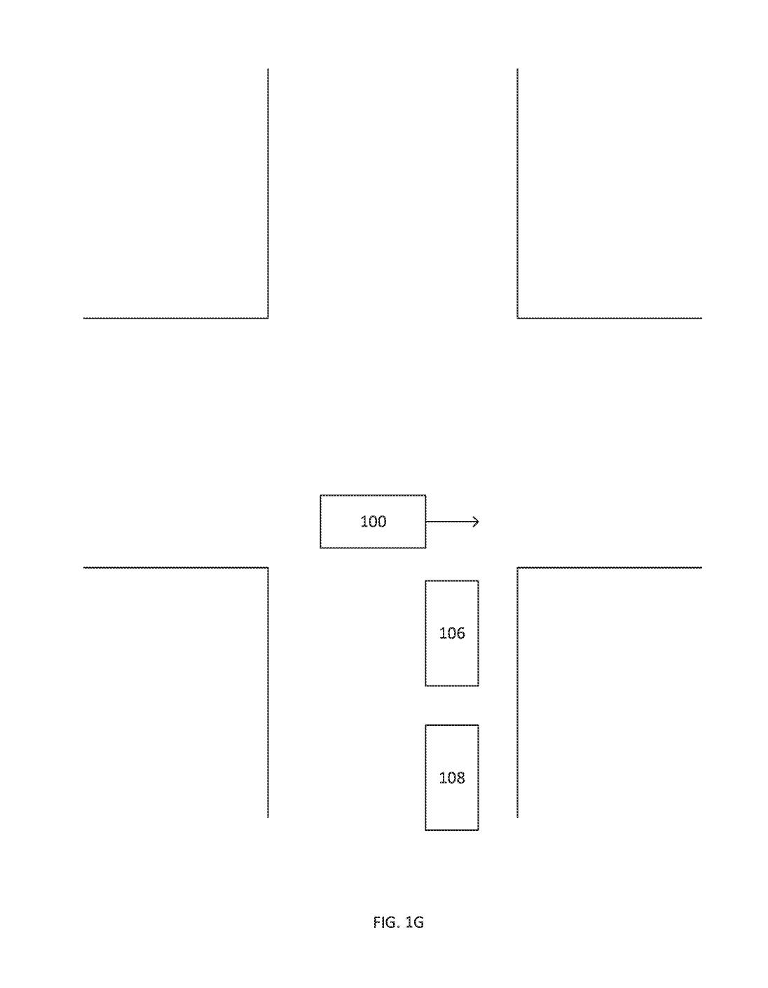

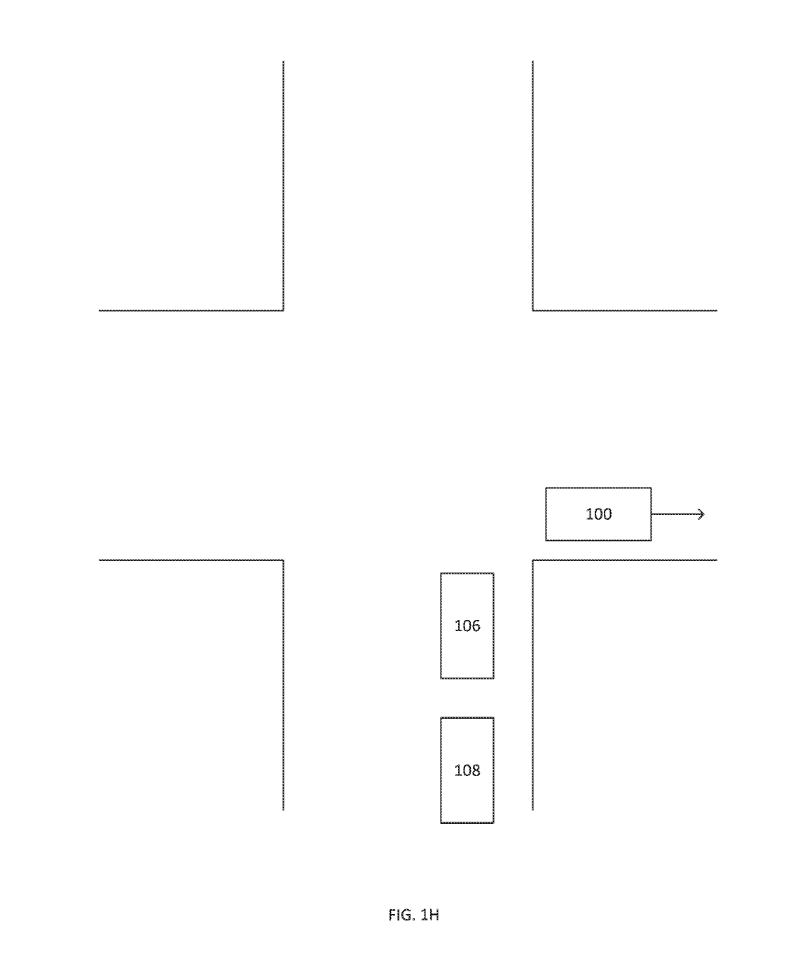

FIGS. 1A-1H illustrate an exemplary intersection negotiation according to examples of the disclosure. In FIG. 1A, a first vehicle 100 has arrived at an intersection along with second vehicle 102 and third vehicle 104. The first vehicle 100 is capable of detecting proximity to the intersection in a number of different ways. For example, the first vehicle can use a camera to capture an image and determine whether the image includes a visual indicator of an intersection (e.g., a stop sign or crosswalk). The first vehicle can also use map data that includes the intersection and a location device (e.g., a GPS device) to determine that the first vehicle is proximate to the intersection. In some examples, either the camera or the map data can be used to determine that the first vehicle 100 is approaching the intersection, and speed of the first vehicle 100 can be decreased in response. As the first vehicle 100 arrives at the edge of the intersection, intersection proximity can be confirmed by checking either one of or both the camera and the map data to verify that the first vehicle 100 has arrived at an entry of the intersection.

In response to the verification that the first vehicle 100 has arrived at an entry of the intersection, the first vehicle 100 can come to a complete stop and send a message indicating its time of arrival to any other vehicles also present at the intersection (e.g., second vehicle 102 and third vehicle 104). Further, the first vehicle 100 can request times of arrival of the other vehicles in the intersection by sending requests to the second vehicle 102 and the third vehicle 104. In response to the requests, the second vehicle 102 and the third vehicle 104 can send their respective times of arrival to the first vehicle 100. In some examples, the information can be sent as a broadcast message to any vehicles in the area. In other examples, the information can be targeted to particular vehicles and/or can include encryption or other security protocols to secure the information and ensure only the targeted vehicles can read the information. In some examples, the information can include other information besides time of arrival, such as an identifier of the intersection, an identifier of the vehicle sending the information, a location of the vehicle sending the information, and/or a destination.

Once the first vehicle 100 receives times of arrival from all other vehicles at the intersection, the first vehicle can determine whether to enter the intersection. For example, if the time of arrival of the first vehicle is earlier than both the time of arrival of the second vehicle 102 and the third vehicle 104, then the first vehicle can enter the intersection. However, if the first vehicle's time of arrival is not the earliest, then it can wait for at least one other vehicle to enter and exit the intersection. Each of the three vehicles at the intersection can perform this same method to determine whether it should enter the intersection. If two or more vehicles arrive at the same time at the intersection, then a priority of entry can be determined by applicable traffic rules (e.g., the vehicles to the right has right of way).

FIG. 1B illustrates a second vehicle 102 entering the intersection after determining the time of arrival of the second vehicle 102 is earlier than the time of arrival of both the first vehicle 100 and the third vehicle 104. Upon entering the intersection, the second vehicle 102 can send a message to the first vehicle 100 and the third vehicle 104 indicating that it has entered the intersection. FIG. 1C illustrates the second vehicle 102 exiting the intersection. Upon exiting the intersection, the second vehicle 102 can send a message to the first vehicle 100 and the third vehicle 104 indicating that it has exited the intersection. According to the negotiation method, the first vehicle 100 and the third vehicle 104 may not enter the intersection after receiving the message that the second vehicle 102 has entered the intersection, until a message is received indicating that the second vehicle 102 has exited the intersection. Each vehicle can determine whether it has entered or exited the intersection based on map (e.g., GPS) data, directional/velocity data, and/or visual data such as distance to a distant object.

FIG. 1D illustrates fourth vehicle 106 and fifth vehicle 108 approaching the intersection. Fourth vehicle 106 has arrived at the entry of the intersection, and thus it can send a message indicating its time of arrival to the first vehicle 100 and the third vehicle 104. Further, the fourth vehicle 106 can request times of arrival of the other vehicles in the intersection by sending requests to the first vehicle 100 and the third vehicle 104. In response to the requests, the first vehicle 100 and the third vehicle 104 can send their respective times of arrival to the fourth vehicle 106. Because the fifth vehicle 108 is behind the fourth vehicle 106, it has not yet arrived at the intersection, and thus it may not yet register a time of arrival and send that time of arrival to the other vehicles. The fifth vehicle can determine that it is behind another vehicle using data received from its radar or ultrasonic sensors or camera.

FIG. 1E illustrates the third vehicle 104 entering the intersection after determining the time of arrival of the third vehicle is earlier than the time of arrival of both the first vehicle 100 and the fourth vehicle 106. Upon entering the intersection, the third vehicle 104 can send a message to the first vehicle 100 and the fourth vehicle 106 indicating that it has entered the intersection. FIG. 1F illustrates the third vehicle 104 exiting the intersection. Upon exiting the intersection, the third vehicle 104 can send a message to the first vehicle 100 and the fourth vehicle 106 indicating that it has exited the intersection. According to the negotiation method, the first vehicle 100 and the fourth vehicle 106 may not enter the intersection after receiving the message that the third vehicle 104 has entered the intersection, until a message is received indicating that the third vehicle 104 has exited the intersection.

FIG. 1G illustrates the first vehicle 100 entering the intersection after determining the time of arrival of the first vehicle is earlier than the time of arrival of the fourth vehicle 106. Upon entering the intersection, the first vehicle 100 can send a message to the fourth vehicle 106 indicating that it has entered the intersection. FIG. 1H illustrates the first vehicle 100 exiting the intersection. Upon exiting the intersection, the first vehicle 100 can send a message to the fourth vehicle 106 indicating that it has exited the intersection. According to the negotiation method, the fourth vehicle 106 may not enter the intersection after receiving the message that the first vehicle 100 has entered the intersection, until a message is received indicating that the first vehicle 100 has exited the intersection.

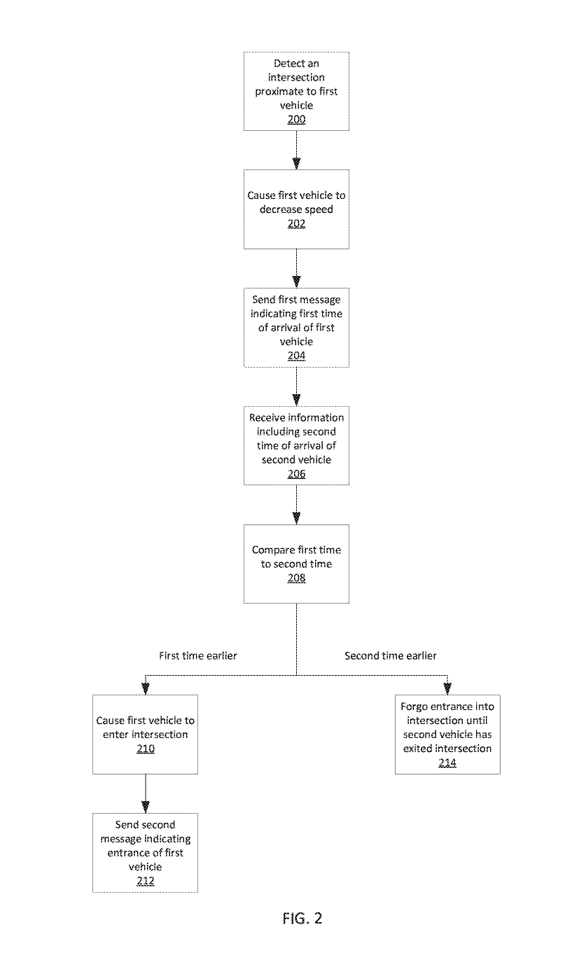

FIG. 2 illustrates an exemplary method of intersection negotiation according to examples of the disclosure.

A first vehicle (e.g., first vehicle 100 or any of the other vehicles in FIGS. 1A-1H) can detect (200) an intersection proximate to the first vehicle. For example, the first vehicle can include a camera, and the vehicle can capture, using the camera, an image. The vehicle can recognize a stop sign (or other visual indicator of an intersection) within the image using image-recognition techniques, and detect that the intersection is proximate to the first vehicle in accordance with recognizing the stop sign within the image, and determine a distance from the stop sign using information such as the size of the stop sign within the image, the focal length of the imaging device, and/or the reproduction ratio of the image. Exemplary stop sign recognition algorithms are described in “Road sign recognition from a moving vehicle” (Björn Johansson, Master's thesis, Centre for Image Analysis, Uppsala University (2002)), the contents of which are hereby incorporated by reference for all purposes. In some examples, the first vehicle can include a location device (e.g., GPS, or other location device), and the first vehicle can determine, using the location device a location of the first vehicle with respect to map data that includes the intersection. The vehicle can then detect that the intersection is proximate to the first vehicle in accordance with determining the location of the first vehicle with respect to the map data. In some examples, the intersection can be considered “proximate” to the vehicle based on a predetermined threshold, such as predetermined distance from the vehicle to the intersection based on the location of the vehicle with respect to map data, or a predetermined distance from the vehicle as estimated from one or more camera images that include a visual indicator of an intersection, such as a stop sign.

In response to detecting an intersection, components (e.g., one or more processors or other controllers) of the first vehicle 100 can cause (202) the first vehicle to automatically decrease speed, eventually slowing to a stop at an entry point of the intersection. Then, the first vehicle 100 can send (204) a first message indicating a first time of arrival of the first vehicle 100 at the intersection (e.g., to other vehicles that have stopped at the intersection). In some examples, any messages or other information sent between the first vehicle 100 and other vehicles at the intersection may be sent using a wireless communication protocol (e.g., dedicated short range communications (DSRC), cellular, etc.). In some examples, the messages may be direct vehicle-to-vehicle communications, and in other examples, the messages may be sent over a communication network, such as a cellular network, a WiFi network, Bluetooth connection, or the Internet, among other possibilities.

The first vehicle 100 can receive (206) information including a second time of arrival of a second vehicle at the intersection. For example, the first vehicle may, upon arriving at the intersection, send a request for times of arrival, and the information including the second time of arrival of the second vehicle can be sent by the second vehicle in response to receiving the request for times of arrival. In some examples, vehicles may periodically broadcast time of arrival information to other vehicles at the same intersection without needing to first receive a request for such information. In some examples, a vehicle may send its time of arrival information as a response to receiving time of arrival information from another vehicle at the intersection without needing to receive a specific request for such information.

The first vehicle can then compare (208) the first time to the second time to determine which time of arrival is earlier.

In accordance with the first time being earlier than the second time, components (e.g., one or more processors or other controllers) of the first vehicle can cause (210) the first vehicle to automatically enter the intersection. Then, the first vehicle can send (212) a second message indicating entrance of the first vehicle into the intersection. The first vehicle can automatically traverse the intersection, and, after the first vehicle has exited the intersection, it can send a message to other vehicles at the intersection indicating the first vehicle has exited the intersection. In some examples, if there are multiple vehicles and multiple times of arrival to consider, the first vehicle may enter the intersection before any of the other vehicles only if the first time is earlier than any of the other times of arrival.

In accordance with the first time not being earlier than the second time, the first vehicle can forgo (214) entrance into the intersection until the second vehicle has exited the intersection. Further, the first vehicle may not enter the intersection until all other vehicles with earlier times of arrival have entered and then exited the intersection (e.g., as indicated by messages/information received from those vehicles).

For example, after receiving additional information indicating the second vehicle has exited the intersection, if a third vehicle has an earlier time of arrival than the first vehicle, the first vehicle can continue to forgo entering the intersection until the third vehicle has entered and exited the intersection. If, however, the third vehicle has a later time of arrival and there are no other vehicles at the intersection with a time of arrival earlier than the first vehicle, then the first vehicle can enter the intersection as soon as the second vehicle has exited.

In some embodiments, the first vehicle may detect another vehicle proximate to the intersection without receiving information indicating a time of arrival of that other vehicle. For example, the other vehicle may be detected by the first vehicle using a camera, LIDAR, or other system, and if the other vehicle is not automated or does not use the same negotiating method, then it may not broadcast its time of arrival. In such a case, the first vehicle may forgo entrance into the intersection until the other vehicle has exited the intersection. Because the other vehicle may not broadcast its entrance and exit of the intersection, it may be necessary for the first vehicle to use a camera, LIDAR, etc. to detect the entrance and exit of the other vehicle to be sure that the other vehicle has left the intersection before the first vehicle enters. Alternatively, in other examples, vehicles can broadcast a “I am in the intersection” signal while the vehicle is traversing through the intersection, and other vehicles will await the termination of such a signal before entering the intersection.

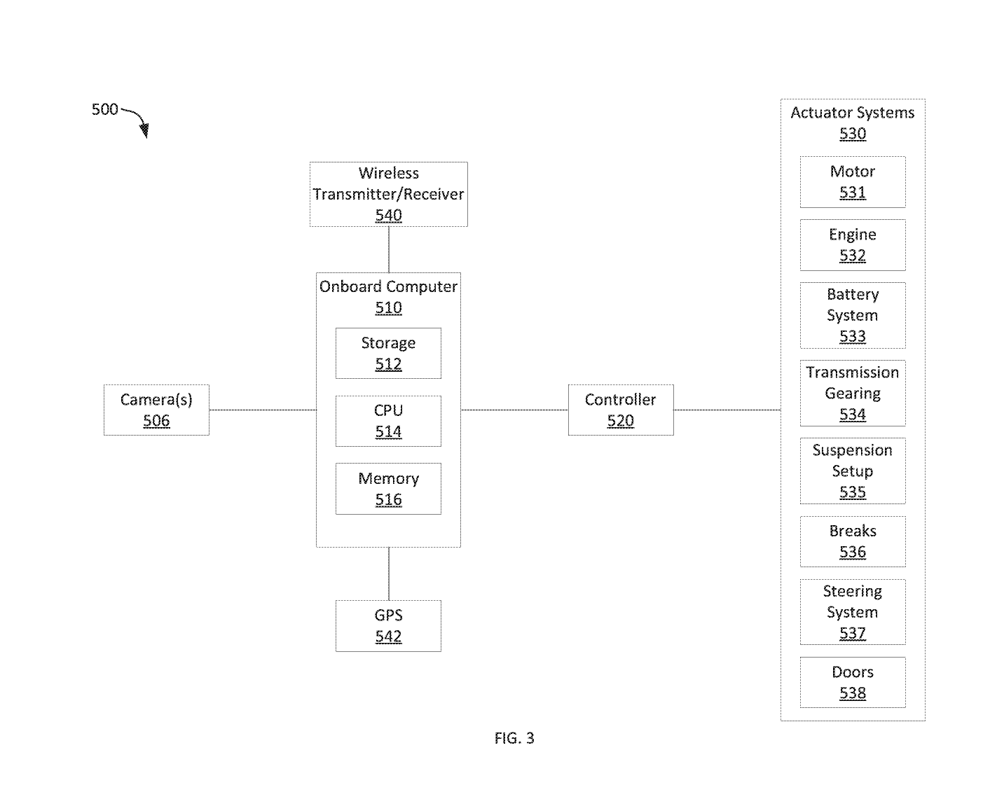

FIG. 3 illustrates a system block diagram according to examples of the disclosure. Vehicle control system 500 can perform any of the methods described with reference to FIGS. 1A-2. System 500 can be incorporated into a vehicle, such as a consumer automobile. Other example vehicles that may incorporate the system 500 include, without limitation, airplanes, boats, or industrial automobiles. Vehicle control system 500 can include one or more cameras 506 capable of capturing image data (e.g., video data), as previously described. Vehicle control system 500 can include an on-board computer 510 coupled to the cameras 506, and capable of receiving the image data from the camera, as described in this disclosure. On-board computer 510 can include storage 512, memory 516, and a processor 514. Processor 514 can perform any of the methods described with reference to FIGS. 1A-2. Additionally, storage 512 and/or memory 516 can store data and instructions for performing any of the methods described with reference to FIGS. 1A-2. Storage 512 and/or memory 516 can be any non-transitory computer readable storage medium, such as a solid-state drive or a hard disk drive, among other possibilities. The vehicle control system 500 can include a wireless transmitter/receiver 540 (e.g., Wi-Fi, cellular, Bluetooth, NFC, etc.) for sending and receiving messages from other systems and/or vehicles as described above. The vehicle control system 500 can include a GPS system 542 or other location-determining hardware for obtaining a location of the vehicle as described above. The vehicle control system 500 can also include a controller 520 capable of controlling one or more aspects of vehicle operation.

In some examples, the vehicle control system 500 can be connected to (e.g., via controller 520) one or more actuator systems 530 in the vehicle. The one or more actuator systems 530 can include, but are not limited to, a motor 531 or engine 532, battery system 533, transmission gearing 534, suspension setup 535, brakes 536, steering system 537 and door system 538. Based on the determined locations of one or more objects relative to the interaction spaces of doors 538, the vehicle control system 500 can control one or more of these actuator systems 530 to stop before entering an intersection and/or to traverse an intersection, by adjusting the steering angle and engaging the drivetrain (e.g., motor) to move the vehicle at a controlled speed. The camera system 506 can continue to capture images and send them to the vehicle control system 500 for analysis, as detailed in the examples above. The vehicle control system 500 can, in turn, continuously or periodically send commands to the one or more actuator systems 530 to control movement of the vehicle.

Thus, the examples of the disclosure provide various ways to safely and efficiently negotiate intersection traversal between multiple automated vehicles without the need for an external arbitration device.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A non-transitory computer readable storage medium, storing instructions which, when executed by a first vehicle including one or more processors, cause the first vehicle to perform a method of negotiating traversal of an intersection, the method comprising:
detecting an intersection proximate to the first vehicle;
in response to detecting the intersection, causing the first vehicle to decrease speed, and sending a first message indicating a first time of arrival of the first vehicle at the intersection;
receiving information including a second time of arrival of a second vehicle at the intersection;
comparing the first time to the second time;
in accordance with the first time being earlier than the second time, causing the first vehicle to enter the intersection, and sending a second message indicating entrance of the first vehicle into the intersection; and
in accordance with the first time not being earlier than the second time, forgoing entrance into the intersection until the second vehicle has exited the intersection.

2. The non-transitory computer readable storage medium of claim 1, wherein the information further includes a third time of arrival of a third vehicle at the intersection, the method further comprising:
receiving additional information indicating the second vehicle has exited the intersection; and
in response to receiving the additional information indicating the second vehicle has exited the intersection, comparing the first time to the third time;
in accordance with the first time being earlier than the third time, causing the first vehicle to enter the intersection, and sending a second message indicating entrance of the first vehicle into the intersection; and
in accordance with the first time not being earlier than the third time, forgoing entrance into the intersection until the third vehicle has exited the intersection.

3. The non-transitory computer readable storage medium of claim 1, wherein the second time is earlier than the first time, the method further comprising:
after receiving the information including the second time, receiving additional information including a third time of arrival of a third vehicle at the intersection, wherein the third time is later than the first time.

4. The non-transitory computer readable storage medium of claim 1, wherein the first vehicle further includes a camera, the method further comprising:
capturing, using the camera, an image; and
recognizing a stop sign within the image;
wherein the intersection is detected proximate to the first vehicle in accordance with recognizing the stop sign within the image.

5. The non-transitory computer readable storage medium of claim 1, wherein the first vehicle further includes a location device, the method further comprising:
determining, using the location device, a location of the first vehicle with respect to map data that includes the intersection;
wherein the intersection is detected proximate to the first vehicle in accordance with determining the location of the first vehicle with respect to the map data.

6. The non-transitory computer readable storage medium of claim 1, wherein the first vehicle receives the first information from the second vehicle using a wireless communication protocol, and the first vehicle sends the first and second messages to the second vehicle using the wireless communication protocol.

7. The non-transitory computer readable storage medium of claim 1, the method further comprising:
sending a request for times of arrival, wherein the information including the second time of arrival of the second vehicle is sent by the second vehicle in response to receiving the request for times of arrival.

8. The non-transitory computer readable storage medium of claim 1, the method further comprising:
detecting a third vehicle proximate to the intersection without receiving information indicating a time of arrival of the third vehicle; and
in accordance with detecting the third vehicle without receiving information indicating the time of arrival of the third vehicle, forgoing entrance into the intersection until the third vehicle has exited the intersection.

9. The non-transitory computer readable storage medium of claim 1, wherein the information includes a plurality of times of arrival of a plurality of vehicles at the intersection, the method further comprising:
causing the first vehicle to enter the intersection before any of the plurality of vehicles in accordance with the first time being earlier than any of the plurality of times.

10. The non-transitory computer readable storage medium of claim 1, the method further comprising:
after the first vehicle has exited the intersection, sending a third message indicating the first vehicle has exited the intersection.

11. A first vehicle comprising:
one or more processors; and
a memory storing instructions which, when executed by the one or more processors, cause the first vehicle to perform a method of negotiating traversal of an intersection, the method comprising:
detecting an intersection proximate to the first vehicle;
in response to detecting the intersection, causing the first vehicle to decrease speed, and sending a first message indicating a first time of arrival of the first vehicle at the intersection;
receiving information including a second time of arrival of a second vehicle at the intersection;
comparing the first time to the second time;
in accordance with the first time being earlier than the second time, causing the first vehicle to enter the intersection, and sending a second message indicating entrance of the first vehicle into the intersection; and
in accordance with the first time not being earlier than the second time, forgoing entrance into the intersection until the second vehicle has exited the intersection.

12. The first vehicle of claim 11, wherein the information further includes a third time of arrival of a third vehicle at the intersection, the method further comprising:
receiving additional information indicating the second vehicle has exited the intersection; and
in response to receiving the additional information indicating the second vehicle has exited the intersection, comparing the first time to the third time;
in accordance with the first time being earlier than the third time, causing the first vehicle to enter the intersection, and sending a second message indicating entrance of the first vehicle into the intersection; and
in accordance with the first time not being earlier than the third time, forgoing entrance into the intersection until the third vehicle has exited the intersection.

13. The first vehicle of claim 11, wherein the second time is earlier than the first time, the method further comprising:
after receiving the information including the second time, receiving additional information including a third time of arrival of a third vehicle at the intersection, wherein the third time is later than the first time.

14. The first vehicle of claim 11, wherein the first vehicle further includes a camera, the method further comprising:
capturing, using the camera, an image; and
recognizing a stop sign within the image;
wherein the intersection is detected proximate to the first vehicle in accordance with recognizing the stop sign within the image.

15. The first vehicle of claim 11, wherein the first vehicle further includes a location device, the method further comprising:
determining, using the location device, a location of the first vehicle with respect to map data that includes the intersection;
wherein the intersection is detected proximate to the first vehicle in accordance with determining the location of the first vehicle with respect to the map data.

16. The first vehicle of claim 11, wherein the first vehicle receives the first information from the second vehicle using a wireless communication protocol, and the first vehicle sends the first and second messages to the second vehicle using the wireless communication protocol.

17. The first vehicle of claim 11, the method further comprising:
sending a request for times of arrival, wherein the information including the second time of arrival of the second vehicle is sent by the second vehicle in response to receiving the request for times of arrival.

18. The first vehicle of claim 11, the method further comprising:
detecting a third vehicle proximate to the intersection without receiving information indicating a time of arrival of the third vehicle; and
in accordance with detecting the third vehicle without receiving information indicating the time of arrival of the third vehicle, forgoing entrance into the intersection until the third vehicle has exited the intersection.

19. The first vehicle of claim 11, wherein the information includes a plurality of times of arrival of a plurality of vehicles at the intersection, the method further comprising:
causing the first vehicle to enter the intersection before any of the plurality of vehicles in accordance with the first time being earlier than any of the plurality of times.

20. The first vehicle of claim 11, the method further comprising:
after the first vehicle has exited the intersection, sending a third message indicating the first vehicle has exited the intersection.
